(19) United States
(12) Patent Application Publication
(10) Pub. No.: US 2026/0049010 A1
(43) Pub. Date: Feb. 19, 2026

(54) SYSTEM FOR TREATING WASTEWATER USING ELECTROCHEMISTRY

(71) Applicant: The United States of America, as represented by the Secretary of Agriculture, Washington, DC (US)

(72) Inventors: MATIAS B. VANOTTI, FLORENCE, SC (US); ARIEL A. SZOGI, FLORENCE, SC (US); Percy William BRIGMAN, Latta, SC (US); Sunil Rawal, Florence, SC (US)

(21) Appl. No.: 18/808,123

(22) Filed: Aug. 19, 2024

(51) Int. Cl. C02F 1/469; C02F 1/20; C02F 1/26; C02F 1/461; C02F 1/52; C02F 101/10; C02F 101/16; C02F 103/20

(52) U.S. Cl. CPC C02F 1/4695; C02F 1/20; C02F 1/26; C02F 1/46104; C02F 1/46109; C02F 1/5254; C02F 2001/46142; C02F 2101/105; C02F 2101/16; C02F 2103/20; C02F 2201/46115; C02F 2201/4616; C02F 2201/4618; C02F 2305/023

(57) ABSTRACT

Systems and methods for treating wastewater using electrochemistry are disclosed. This disclosure relates to a wastewater treatment system comprising a cathode chamber, wherein a cathode is disposed in the cathode chamber, an anode chamber, wherein an anode is disposed in the anode chamber, and wherein a cation exchange membrane is disposed between the anode chamber and cathode chamber and allows the passage of ammonium from the anode chamber into the cathode chamber. A wastewater stream may be in fluid communication with the cathode chamber. Wastewater from the anode chamber may be passed through a centrifuge or filter. A phosphorous recovery tank may be in fluid communication with the anode chamber. The cathode may accelerate the rate of passage of ammonia through a gas-permeable membrane into an acid-stripping solution contained in a stripping tank. A salt solution may be added to the cathode chamber.

### FIELD

The disclosed subject matter relates generally to systems and methods for treating wastewater using electrochemistry. Specifically, the subject matter described herein relates to systems and methods for nitrogen and phosphorous recovery from wastewater using electrochemistry.

### BACKGROUND

Phosphorus (P) built up in soils to excessively high levels due to animal manures often results in eutrophication and pollution of surface waters. Therefore, the ability to extract phosphorus from manure will be critical to our ability to utilize waste through land application without elevating soil phosphorus levels. Another environmental and regulatory concern is the excess nitrogen (N) in manure from confined livestock production. Due to these concerns, farmers will be much more willing to adopt new manure technology that addresses these phosphorus and nitrogen issues.

Nutrient pollution is one of America's most widespread, costly, and challenging environmental problems. It is caused by too much nitrogen and phosphorus in the environment. Nutrient pollution has diverse and far-reaching effects on the U.S. economy, impacting many sectors that depend on clean water. The U.S. tourism industry loses about $1 billion each year, mostly from losses in fishing and recreational activities because of nutrient-polluted water bodies. As a result of phosphorus pollution, algal blooms in drinking water sources can drastically increase treatment costs and shortages in water supplies, such as in the Lake Erie watershed. Conservation and recovery of nitrogen from livestock, industrial, and municipal wastes are important for economic and environmental reasons.

Recovery of ammonia (NH₃) (in addition to removal) is a desirable feature in agriculture because of the high cost of commercial nitrogen fertilizers. The recovered N can be exported off the farm, solving problems of nitrogen surpluses in concentrated animal production regions. In the United States, the largest source of ammonia emissions is livestock farming, contributing 2.5 million tons/year (EPA, 2014). The development of technologies for nutrient reuse was identified as one of the five main challenges in waste management within a circular economy. Nitrogen is a critical element in the food-energy-water nexus, and its global supply as N-fertilizers depends primarily on the energy-intensive Haber-Bosch process, accounting for about 1.5% of global carbon dioxide (CO₂) emissions (greenhouse gas). It is estimated that about 30% of the global N-fertilizer production (118 Tg N/year) ends up as human waste that is destructively removed in sewage treatment plants prior to disposal of the effluent.

Various methods and systems for recovering ammonia or phosphorous can be found, for example, in: U.S. Pat. No. 9,005,333 entitled “Systems and methods for reducing ammonia emissions from and for recovering the ammonia liquid effluents,” U.S. Pat. No. 9,708,200 Systems and methods for reducing ammonia emissions from liquid effluents and for recovering the ammonia,” U.S. Pat. No. 8,673,046 entitled “Process for removing and recovering phosphorus from animal waste,” U.S. Pat. No. 7,674,379 entitled “Wastewater treatment system with simultaneous separation of phosphorus and manure solids,” and U.S. Pat. No. 6,893,567 entitled “Wastewater treatment system,” which are each incorporated herein by reference in their entirety.

While the existing systems and methods are useful to a degree, they still suffer from certain limitations. Therefore, there exists a need in the art for improved systems and methods for nitrogen and phosphorous recovery from wastewater that solve or at least alleviate some or all of these problems.

### SUMMARY OF THE EMBODIMENTS

Systems and methods for treating wastewater using electrochemistry are disclosed and claimed herein.

As described more fully below, the devices and processes of the embodiments disclosed permit improved systems and methods for treating wastewater using electrochemistry. Further aspects, objects, desirable features, and advantages of the systems and methods disclosed herein will be better understood and apparent to one skilled in the relevant art in view of the detailed description and drawings that follow, in which various embodiments are illustrated by way of example. It is to be expressly understood, however, that the drawings are for the purpose of illustration only and are not intended as a definition of the limits of the claimed embodiments.

To this end, a wastewater treatment system is provided, the wastewater treatment system comprising: a cathode chamber, wherein a cathode is disposed in the cathode chamber, and wherein the cathode chamber is configured to receive a volume of wastewater; an anode chamber, wherein an anode is disposed in the anode chamber; a cation exchange membrane disposed between the anode chamber and cathode chamber, wherein the cation exchange membrane allows the passage of ammonium (NH₄) from the anode chamber into the cathode chamber; and a phosphorous recovery tank. In various embodiments, the phosphorous recovery tank may be in fluid communication with the anode chamber.

In one form, a wastewater treatment system is provided, the wastewater treatment system comprising: a cathode chamber, wherein the cathode chamber is configured to receive a volume of wastewater; a cathode, wherein the cathode is configured to be disposed in the cathode chamber; an anode chamber, wherein an anode is configured to be disposed in the anode chamber; a pump, wherein the pump is configured to move the volume of wastewater from the cathode chamber to the anode chamber; and a cation exchange membrane disposed between the anode chamber and cathode chamber, wherein the cation exchange membrane allows the passage of ammonium from the anode chamber into the cathode chamber.

In some embodiments, the volume of wastewater comprises ammonia and phosphorus. In some embodiments, the wastewater treatment system further comprises a wastewater stream in fluid communication with the cathode chamber; wherein the wastewater stream comprises ammonia and phosphorus. In certain embodiments, the wastewater treatment system further comprises a pump, wherein the pump is capable of moving wastewater from the wastewater stream from the cathode chamber to the anode chamber. In various embodiments, a salt solution is added to the cathode chamber. In some embodiments, the salt solution comprises sodium sulfate, potassium sulfate, potassium chloride, or sodium chloride. In certain embodiments, the salt solution comprises water having sodium sulfate, potassium sulfate, potassium chloride, or sodium chloride. In some embodiments, a salt is added to the cathode chamber. In various embodiments, a salt is added to the cathode chamber wastewater. In certain embodiments, the salt is sodium sulfate (Na₂SO₄), potassium sulfate (K₂SO₄), potassium chloride (KCl), or sodium chloride (NaCl).

In certain embodiments, the carbonate alkalinity is capable of being removed in the anode chamber. In some embodiments, the cathode chamber further comprises a submerged gas-permeable membrane manifold. In various embodiments, ammonia is capable of being removed from the volume of wastewater in the cathode chamber.

In some embodiments, the wastewater treatment system further comprises a centrifuge, wherein the centrifuge is in fluid communication with the anode chamber and the phosphorous recovery tank. In certain embodiments, the wastewater treatment system further comprises a filter, wherein the filter is disposed between the anode chamber and the phosphorous recovery tank. In various embodiments, the wastewater treatment system further comprises a phosphorus precipitating agent dispenser. In some embodiments, the cathode is a platinized titanium cathode, or wherein the anode is a platinized titanium anode. In certain embodiments, the wastewater treatment system further comprises a power supply electrically connected to the cathode and the anode.

In various embodiments, the wastewater treatment system further comprises wherein the volume of wastewater from the anode chamber is passed through a centrifuge. In some embodiments, a phosphorus precipitating compound is added to the volume of wastewater in amounts to match the phosphorus concentration of the volume of wastewater. In certain embodiments, the phosphorus precipitating compound is magnesium chloride (MgCl₂) or calcium hydroxide (Ca(OH)₂).

In some embodiments, an alkaline earth base may be added to the wastewater to precipitate soluble phosphate. In various embodiments, the alkaline earth base may be calcium hydroxide (Ca(OH)₂), magnesium hydroxide (Mg(OH)₂), calcium oxide (CaO), magnesium oxide (MgO), and mixtures thereof. In some embodiments, a metallic-containing salt or hydroxide may be added to wastewater having a pH of at least about pH 9 to precipitate phosphate. In certain embodiments, the metallic-containing salt or hydroxide is an alkaline earth metal-containing salt or hydroxide. In some embodiments, the phosphorus precipitating compound is an alkaline earth metal-containing salt or hydroxide selected from the group comprising calcium, magnesium, and mixtures thereof.

In one form, a liquid effluent treatment system is provided, the liquid effluent treatment system comprising: a cathode chamber, wherein a cathode is disposed in the cathode chamber, and wherein the cathode chamber is configured to receive a liquid effluent; an anode chamber, wherein an anode is disposed in the anode chamber; a cation exchange membrane disposed between the anode chamber and cathode chamber, wherein the cation exchange membrane allows the passage of ammonium from the anode chamber into the cathode chamber; and a gas-permeable membrane disposed in the cathode chamber.

In one form, a liquid effluent treatment system is provided, the liquid effluent treatment system comprising: a cathode chamber, wherein a cathode is disposed in the cathode chamber, wherein the cathode chamber is configured to receive a liquid effluent, and wherein the cathode chamber is configured to receive a solution comprising a salt; an anode chamber, wherein an anode is disposed in the anode chamber, and wherein the anode chamber is configured to receive a liquid effluent; a cation exchange membrane disposed between the anode chamber and cathode chamber, wherein the cation exchange membrane is configured to allow the passage of ammonium from the anode chamber into the cathode chamber.

In some embodiments, the liquid effluent treatment system further comprises a stripping tank containing an acid-stripping solution, wherein the cathode increases the pH of the liquid effluent and accelerates the rate of passage of ammonia through the gas-permeable membrane into an acid-stripping solution contained in the stripping tank, wherein the acid-stripping solution is recirculated through the gas-permeable membrane in a closed loop. In certain embodiments, the liquid effluent treatment system further comprises a phosphorous recovery tank in fluid communication with the anode chamber. In various embodiments, a salt solution is added to the liquid effluent.

In one form, the present disclosure provides a wastewater treatment system comprising: a cathode chamber, wherein a cathode is disposed in the cathode chamber, and wherein the cathode chamber is configured to receive a volume of wastewater; an anode chamber, wherein an anode is disposed in the anode chamber; and wherein a salt solution is added to the volume of wastewater.

In one form, the present disclosure provides a wastewater treatment system comprising: a cathode chamber, wherein the cathode chamber is configured to receive a salt solution; a cathode, wherein the cathode is configured to be disposed in the cathode chamber; an anode chamber wherein the anode chamber is configured to receive a volume of wastewater; and an anode, wherein the anode is configured to be disposed in the anode chamber.

In certain embodiments, the wastewater treatment system further comprises a cation exchange membrane disposed between the anode chamber and cathode chamber, wherein the cation exchange membrane allows the passage of ammonium from the anode chamber into the cathode chamber. In some embodiments, the wastewater treatment system further comprises a gas-permeable membrane in gaseous communication with the cathode chamber. In various embodiments, the wastewater treatment system further comprises a phosphorous recovery tank in fluid communication with the anode chamber. In certain embodiments, a salt solution is added to the volume of wastewater. In some embodiments, the salt solution is sodium sulfate (Na₂SO₄).

In one form, the present disclosure provides a method of treating wastewater, the method comprising the steps of: pumping a volume of wastewater containing ammonia and phosphorus into a tank, wherein the tank comprises a cathode chamber and an anode chamber; removing ammonia from the volume of wastewater in the cathode chamber; pumping the volume of wastewater from the cathode chamber to an anode chamber; and acidifying the volume of wastewater in the anode chamber.

In various embodiments, the method further comprises the step of pumping the volume of wastewater through a centrifuge or filter to separate solids from liquid. In some embodiments, the method further comprises the step of adding a phosphorus precipitating compound to the volume of wastewater in amounts to match the P concentration of the volume of wastewater. In certain embodiments, the method further comprises the step of mixing to precipitate the phosphorus out of the volume of wastewater as a solid. In some embodiments, the method further comprises the step of adding a salt solution to the volume of wastewater.

In one form, the present disclosure provides a method of treating wastewater, the method comprising the steps of: adding a composition to a cathode chamber, wherein a cathode is disposed in the cathode chamber; adding a first volume of wastewater containing ammonia and phosphorus to an anode chamber, wherein an anode is disposed in the anode chamber; removing ammonia from the composition in the cathode chamber, and acidifying the first volume of wastewater in the anode chamber.

In some embodiments, the composition is a second volume of wastewater. In various embodiments, the composition is a salt solution. In certain embodiments, the method further comprises the step of adding a salt solution to the composition. In some embodiments, the method further comprises the step of transferring the composition from the cathode chamber to an anode chamber. In various embodiments, the method further comprises the step of transferring the first volume of wastewater through a centrifuge or filter to separate solids from liquid. In certain embodiments, the method further comprises the step of adding a phosphorus precipitating compound to the first volume of wastewater. In some embodiments, the method further comprises the step of mixing to precipitate phosphorus out of the first volume of wastewater as a solid. In various embodiments, a cation exchange membrane is disposed between the anode chamber and cathode chamber, wherein the cation exchange membrane allows the passage of ammonium from the anode chamber into the cathode chamber. In some embodiments, a power supply is electrically connected to the cathode and the anode.

These and other objects, features, aspects, and advantages of the present patent document will become better understood with reference to the following description and accompanying drawings.

### BRIEF DESCRIPTION OF THE DRAWINGS

FIG. 1 illustrates a schematic diagram of a side cross sectional view of an embodiment of a system for treating wastewater using electrochemistry of the present patent document.

FIG. 2 illustrates a schematic diagram of a side cross sectional view of another embodiment of a system for treating wastewater using electrochemistry of the present patent document.

FIG. 3 illustrates a graph A) showing the total phosphorous in treated effluents after adding P-precipitating agents with a previous electrochemical step, and a graph B) showing the total phosphorous in treated effluents after adding P-precipitating agents without an electrochemical step according to the embodiment shown in FIG. 1 of the present patent document.

FIG. 4 illustrates a graph A) showing the soluble phosphorous in treated effluents after adding P-precipitating agents with a previous electrochemical step, and a graph B) showing the soluble phosphorous in treated effluents after adding P-precipitating agents without a previous electrochemical step according to the embodiment shown in FIG. 1 of the present patent document.

FIG. 5 illustrates a graph A) showing the pH of effluent when treated with different concentrations of P-precipitating agents with a previous electrochemical step, and a graph B) showing the pH of effluent when treated with different concentrations of P-precipitating agents without a previous electrochemical step according to the embodiment shown in FIG. 1 of the present patent document.

FIG. 6 illustrates a graph A) showing the phosphorous recovered in the solid precipitate with a previous electrochemical step, and a graph B) showing the phosphorous recovered in the solid precipitate without a previous electrochemical step according to the embodiment shown in FIG. 1 of the present patent document.

FIG. 7 illustrates a graph showing the NH₄-N (mg/L) according to the embodiment shown in FIG. 1 of the present patent document.

FIG. 8 illustrates a graph showing the N mass (mg) removal according to the embodiment shown in FIG. 1 of the present patent document.

FIG. 9 illustrates a graph showing the pH according to the embodiment shown in FIG. 1 of the present patent document.

FIG. 10 illustrates a graph showing the alkalinity according to the embodiment shown in FIG. 1 of the present patent document.

FIG. 11 illustrates a table showing the N mass balance according to the embodiment shown in FIG. 1 of the present patent document.

FIG. 12 illustrates a table showing the changes in pH, alkalinity and phosphorus composition according to the embodiment shown in FIG. 1 of the present patent document.

FIG. 13 illustrates a table showing the total phosphorus (TP) concentration in the treated effluent using various P-precipitating compounds and rates according to the embodiment shown in FIG. 1 of the present patent document.

FIG. 14 illustrates a table showing the Phosphorus recovered per liter of wastewater according to the embodiment shown in FIG. 1 of the present patent document.

FIG. 15 illustrates a table showing the Ammonia-N mass balance according to the embodiment shown in FIG. 2 of the present patent document.

FIG. 16 illustrates a graph A) showing the phosphate recovered in the solid precipitated with a previous electrochemical step, and a graph B) showing the phosphate recovered in the solid precipitated without a previous electrochemical step according to the embodiment shown in FIG. 2 of the present patent document.

FIG. 17 illustrates a graph showing the NH-4-N (mg/L) according to the embodiment shown in FIG. 2 of the present patent document.

FIG. 18 illustrates a graph showing the N mass (mg) according to the embodiment shown in FIG. 2 of the present patent document.

FIG. 19 illustrates a graph showing the N mass (mg) removal according to the embodiment shown in FIG. 2 of the present patent document.

FIG. 20 illustrates a graph showing the pH according to the embodiment shown in FIG. 2 of the present patent document.

FIG. 21 illustrates a graph showing the alkalinity according to the embodiment shown in FIG. 2 of the present patent document.

FIG. 22 illustrates a method of treating wastewater in accordance with the present patent document.

FIG. 23 illustrates a schematic diagram of a side cross sectional view of another embodiment of a system for treating wastewater using electrochemistry of the present patent document.

FIG. 24 illustrates a schematic diagram of a side cross sectional view of another embodiment of a system for treating wastewater using electrochemistry of the present patent document.

FIG. 25 illustrates another method of treating wastewater in accordance with the present patent document.

Note that assemblies/systems in some of the figures may contain multiple examples of essentially the same component. For simplicity and clarity, only a small number of the example components may be identified with a reference number. Unless otherwise specified, other non-referenced components with essentially the same structure as the exemplary component should be considered to be identified by the same reference number as the exemplary component. Further, unless specifically indicated otherwise, drawing components may or may not be shown to scale.

### DETAILED DESCRIPTION OF PREFERRED EMBODIMENTS

Reference will now be made to the drawings in which the various elements of the present disclosure will be given numerical designations and in which the present disclosure will be discussed so as to enable one skilled in the art to make and use the present disclosure. It is to be understood that the following description is only exemplary of the principles of the present disclosure, and should not be viewed as narrowing the claims. Additionally, it should be appreciated that the components of the individual embodiments discussed may be selectively combined in accordance with the teachings of the present disclosure. Furthermore, it should be appreciated that various embodiments will accomplish different objects of the present disclosure, and that some embodiments falling within the scope of the present disclosure may not accomplish all of the advantages or objects which other embodiments may achieve.

In accordance with the present disclosure, improved systems and methods for treating wastewater using electrochemistry are disclosed which address, or at least ameliorate one or more of the problems of existing designs.

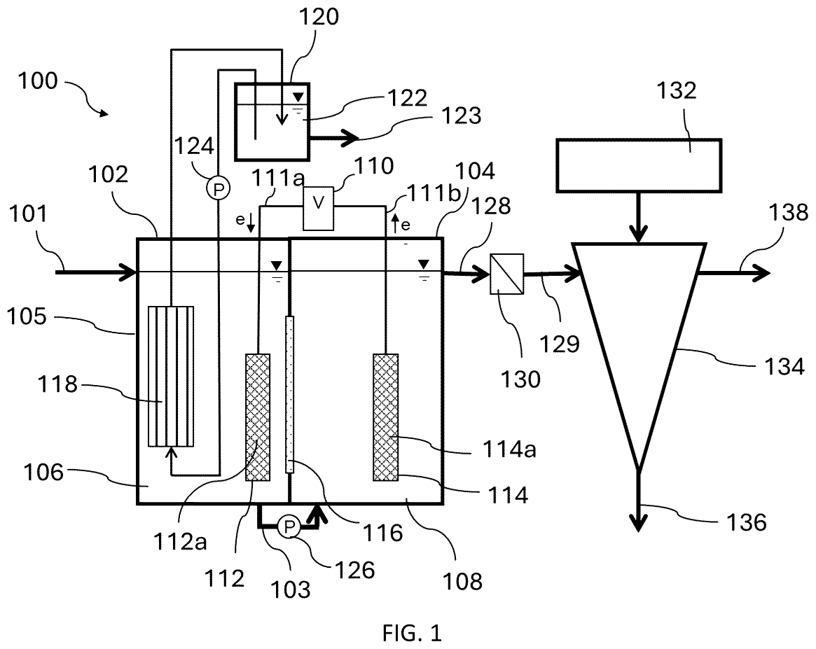

FIG. 1 illustrates a schematic diagram of a side cross sectional view of an embodiment of a system for treating wastewater using electrochemistry of the present patent document. Referring to FIG. 1, there is shown a schematic diagram of a side cross sectional view of an embodiment of a wastewater treatment system 100 of the present patent document. In some embodiments, the wastewater treatment system 100 may be referred to as a liquid effluent treatment system 100. In various embodiments, the wastewater treatment system 100 may have a cathode chamber 102, wherein a cathode 112 may be disposed in the cathode chamber 102. A wastewater stream 101 may be in fluid communication with the cathode chamber 102. The wastewater treatment system 100 may have an anode chamber 104, wherein an anode 114 may be disposed in the anode chamber 104. A cation exchange membrane 116 may be disposed between the anode chamber 104 and cathode chamber 102. The cation exchange membrane 116 may allow for the passage of ammonium from the anode chamber 104 into the cathode chamber 102. In other embodiments, other membranes may be used. A phosphorous recovery tank 134 may be in fluid communication with the anode chamber 104. In some embodiments, the cathode chamber 102 may be configured to comprise a volume of wastewater, and the anode chamber 104 may be configured to comprise another volume of wastewater. In certain embodiments, the wastewater or composition in the cathode chamber 102 may be pumped or otherwise transferred to the anode chamber 104.

In various embodiments, wastewater may be referred to as a liquid effluent. In some embodiments, wastewater in the wastewater stream 101 may comprise animal manure, animal waste, human waste, or sewage. In some embodiments, the wastewater stream 101 may comprise ammonia and phosphorus. The wastewater stream 101 may comprise a volume of wastewater. In some embodiments, the cathode chamber 102 and the anode chamber 104 may be compartments in a tank 105. In certain embodiments, the cathode chamber 102 and the anode chamber 104 may be open to the ambient air. In some embodiments, carbonate alkalinity may be removed from the anode chamber wastewater 108 in the anode chamber 104.

In certain embodiments, the wastewater treatment system 100 may have a pump 126, where the pump 126 moves cathode chamber wastewater 106 from the cathode chamber 102 to the anode chamber 104 by a pathway 103. The pump 126 may be in fluid communication with the cathode chamber 102 and the anode chamber 104. In various embodiments, a pump (e.g., pump 124, 126) may be a peristaltic pump. In some embodiments, a pump may have an intake end and a discharge end. In certain embodiments, a pump may have an intake end and a discharge end, with one tube coupled to the intake end, and a second tube coupled to the discharge end. In other embodiments, a pump may use a single tube.

In various embodiments, ammonia may be removed from the cathode chamber wastewater 106 in the cathode chamber 102. In some embodiments, the cathode chamber 102 may further include a submerged gas-permeable membrane manifold 118. A pump 124 may circulate the stripping solution 122 through a gas-permeable membrane 118 in a closed loop. The gas-permeable membrane 118 may be referred to as a gas-permeable chamber or lumen. In some embodiments, the gas-permeable membrane 118 may have a tubular shape and be referred to as a tubular gas-permeable membrane. In other embodiments, the gas-permeable membrane 118 may be flat. In other embodiments, other shapes for a gas-permeable membrane may be used. In some embodiments, the pump 124 may be a peristaltic pump.

In some embodiments, the wastewater treatment system 100 may further include a centrifuge 130. The centrifuge 130 may be in fluid communication with the anode chamber 104 and the phosphorous recovery tank 134. In other embodiments, the centrifuge 130 may be a filter 130. The filter may be disposed between the anode chamber 104 and the phosphorous recovery tank 134. In various embodiments, the wastewater treatment system 100 may further include a phosphorus precipitating agent dispenser 132.

The cathode 112 and the anode 114 may be made of metal. In some embodiments, the cathode 112 may be a platinized titanium cathode, and the anode 114 may be a platinized titanium anode. In other embodiments, the cathode 112 and the anode 114 may be made of any suitable material. In certain embodiments, the cathode 112 may have spaces 112a between the material of the cathode 112. In various embodiments, the anode 114 may have spaces 114a between the material of the anode 114a. In some embodiments, the spaces 112a and 114a may be referred to as holes or gaps.

In various embodiments, the wastewater treatment system 100 may include where the anode chamber wastewater 108 of the anode chamber 104 may be passed through a centrifuge 130. In some embodiments, a phosphorus precipitating compound may be added to the liquid effluent 129 in the phosphorous recovery tank 134 in amounts to match the phosphorus concentration of the effluent 129. In some embodiments, the effluent 129 may contain phosphate. In certain embodiments, the phosphorus precipitating compound may be magnesium chloride (MgCl₂) or calcium hydroxide (Ca(OH)₂). In other embodiments, any other suitable phosphorus precipitating compounds may be used. In some embodiments, an alkaline earth base may be added to the wastewater to precipitate soluble phosphate. In various embodiments, the alkaline earth base may be one or more of calcium hydroxide, magnesium hydroxide, calcium oxide, magnesium oxide, or mixtures thereof. In some embodiments, a metallic-containing salt or hydroxide may be added to a volume of wastewater having a pH of at least about pH 9 in order to precipitate a phosphate. In certain embodiments, the metallic-containing salt or hydroxide may be an alkaline earth metal-containing salt or hydroxide.

In some embodiments, a cation exchange membrane 116 may be disposed between the anode chamber 104 and cathode chamber 102, which allows the passage of ammonium from the anode chamber 104 into the cathode chamber 102. A gas-permeable membrane 118 may be in fluid communication with the cathode chamber 102. In certain embodiments, the wastewater treatment system 100 may further include a stripping acid solution tank 120, where the stripping acid solution tank 120 may contain an acid-stripping solution 122. The cathode 112 may increase the pH of the liquid effluent and accelerate the rate of passage of ammonia through the gas-permeable membrane 118 into the acid-stripping solution 122 contained in the stripping acid solution tank 120. The acid-stripping solution 122 may be recirculated through the gas-permeable membrane 118 in a closed loop configuration. In certain embodiments, the wastewater treatment system 100 may further include a phosphorous recovery tank 134, where the phosphorous recovery tank 134 may be in fluid communication with the anode chamber 104. In various embodiments, a salt solution may be added to the liquid effluent.

In certain embodiments, the system 100 has a cathode chamber 102, an anode chamber 104, a stripping acid solution tank 120, and a phosphorus recovery tank 134. The wastewater stream 101 containing ammonia and phosphorus may be pumped into the cathode chamber 102. The ammonia removal may be accomplished in the cathode chamber 102, where the cathode chamber 102 may be fitted with a submerged gas-permeable membrane manifold 118. The gas-permeable membrane manifold 118 may be submerged in the cathode chamber wastewater 106. The cathode 112 may increase the pH of the cathode chamber wastewater 106 and thereby accelerate the rate of passage of ammonia through the gas-permeable membrane 118 into an acid-stripping solution 122 contained in a stripping acid solution tank 120. The acid-stripping solution 122 may be recirculated through the membrane manifold 118. The stripping acid solution tank 120 may also be referred to as a reservoir. In some embodiments, ammonia may be captured from wastewater containing ammonia within a gas-permeable membrane manifold 118 by contacting the ammonia with a stripping solution to produce ammonium salts, and then transporting the salts to a reservoir or stripping acid solution tank 120 for collection.

In certain embodiments, the cathode chamber wastewater 106 may be pumped to the anode chamber 104 where the liquid may be acidified by hydrogen ions (H+) released by electrolysis in the anode 114. A cation exchange membrane 116 may be fitted between the anode chamber 104 and cathode chamber 102, where the cation exchange membrane 116 may allow for the passage of ammonium (NH₄) from the anode chamber 104 into the cathode chamber 102. The anode chamber wastewater 108, with most of the P solubilized, may be passed through a centrifuge 130 or filter to separate solids from liquid, where the resulting solids may be solids without phosphorus, and the liquid may be liquid with phosphorus, mostly as soluble phosphate. A phosphorus precipitating compound (e.g., MgCl₂ or Ca(OH)₂) from a phosphorus precipitating agent dispenser 132 may be added to this effluent in amounts to match the P concentration of the effluent. In some embodiments, the phosphorus precipitating compound may be magnesium chloride (MgCl₂). In other embodiments, the phosphorus precipitating compound may be calcium hydroxide (Ca(OH)₂). After rapid mixing phosphorous recovery tank 134, the phosphorus may quickly precipitate as a solid and may then be collected through tube 136. The remaining effluent byproducts may be removed through tube 138. This precipitation may proceed quickly as a result of the previous removal of the carbonate alkalinity in the anode chamber 104, since carbonate alkalinity may interfere with phosphate precipitation.

The top of the cathode chamber 102 and the anode chamber 104 may be open to the ambient air. In other embodiments, the cathode chamber 102 and the anode chamber 104 may be closed off from or sealed from the ambient air.

A power supply 110 may be electrically connected to the cathode 112 and the anode 114. The power supply 110 may be electrically connected to the cathode 112 by a wire 111a. The power supply 110 may be electrically connected to the anode 114 by a wire 111b. In some embodiments, the power supply 110, the cathode 112 and the anode 114 may be referred to as an electrolyzer system. An electrolyzer system may be any device that uses electricity to split components into their constituent elements through electrolysis. An electrolyzer system may contain an electrolytic cell having two electrodes, a negatively charged cathode and a positively charged anode. The electrolyzer system may also contain a membrane located between the cathode and the anode. In some embodiments, an electrolyzer system may include pumps, wires, vents, tanks, and other components. Electrolysis may occur when an electric current is applied across the electrolytes. The anode may attract the negatively charged ions, and the cathode may attract the positively charged ions.

In some embodiments, a volume of wastewater may be pumped through tubes or pipes into the tank 105, and then pumped from one chamber or section of the wastewater system 100 to another. In other embodiments, a volume of wastewater may be manually placed in the tank or in a particular section or chamber, and then manually moved from one chamber or section of the wastewater system to another by any suitable method. For example, the wastewater may be shoveled, scooped, or drained from one chamber, section, or location to another.

For example, in some tests using the system in FIG. 1, using swine manure with 720 mg/L total phosphorus (TP) concentration, only 0.5% (3.5 mg/L) was solubilized. After electrochemical treatment, 99% of the P was in the form of soluble phosphate (o-P), and amenable to removal with P precipitating compounds. The liquid pH in the anode chamber dropped to 1.5, and the carbonate alkalinity was destroyed. The process recovered 92% of the Total P contained in wastewater in a phosphorus solid precipitate. In contrast, only 6% of the total P was recovered in a control that did not receive electrochemical treatment (and acidification). The nitrogen (N) recovery efficiency by the membrane module in the cathode chamber was 92%.

The cation exchange membrane 116 may be any suitable cation exchange membrane (CEM). In some embodiments, the CEM may be made of gel polystyrene cross linked with divinylbenzene. In certain embodiments, for example, the cation exchange membrane may be a commercially available CEM, such as CMI-7000 from Membrane International Inc. The CEM may be any suitable size and shape. In an example, the CEM was cut into disks with a surface area of 22.9 cm².

The gas permeable membrane 118 may be any suitable gas permeable membrane (GPM). In some embodiments, the GPM may be made of expanded polyetrafluoroethylene (ePTFE). In certain embodiments, for example, the gas permeable membrane may be a commercially available GPM that can be used to capture ammonia from the wastewater. The GPM may be any suitable size and shape. In an example, the length of the permeable membrane tube was 16.5 cm, the outer diameter was 10.25 mm, and the wall thickness was 0.75 mm. In such an example, the GPM had a pore size of 2.5 μm, a bubble point of 210 kPa, a polymer density of 0.39 g/cm³, and the surface area of the gas-permeable membrane was 53.1 cm². In such an example, the amount of liquid in the anode chamber was 250 mL. In various embodiments, the GPM may be submerged in a liquid in the cathode chamber.

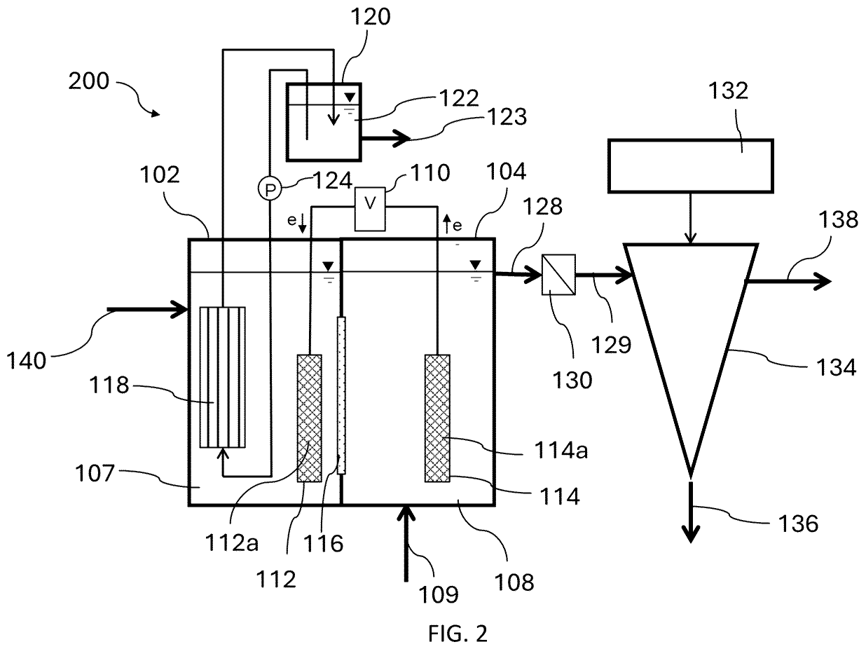

FIG. 2 illustrates a schematic diagram of a side cross sectional view of another embodiment of a system for treating wastewater using electrochemistry of the present patent document. Referring to FIG. 2, there is shown a schematic diagram of a side cross sectional view of an embodiment of a wastewater treatment system 200 of the present patent document. In some embodiments, the wastewater treatment system 200 may be referred to as a liquid effluent treatment system 200. In various embodiments, the wastewater treatment system 200 may have a cathode chamber 102, where a cathode 112 is disposed in the cathode chamber 102. The wastewater treatment system 200 may have an anode chamber 104, where an anode 114 may be disposed in the anode chamber 104. In the embodiment shown in FIG. 2, a wastewater stream 109 may be in fluid communication with the anode chamber 104. In various embodiments, a salt solution 140 may be added to the wastewater treatment system 200. In the embodiment shown in FIG. 2, the salt solution 140 may be added to the cathode chamber 102. The salt solution 140 located in the cathode chamber 102 may be referred to as the cathode chamber salt solution 107. The salt solution 140 may be any suitable salt solution. As non-limiting examples, the salt solution 140 may comprise sodium sulfate (Na₂SO₄), potassium sulfate (K₂SO₄), potassium chloride (KCl), or sodium chloride (NaCl), among others. In certain embodiments, the salt solution 140 may be a solution comprising water with one or more salts.

In various embodiments, the wastewater treatment system 200 may include a cation exchange membrane 116 disposed between the anode chamber 104 and cathode chamber 102, where the cation exchange membrane 116 allows the passage of ammonium from the anode chamber wastewater 108 of the anode chamber 104 into the cathode chamber salt solution 107 in the cathode chamber 102. In some embodiments, the wastewater treatment system 200 may include a gas-permeable membrane 118 in gaseous communication with the cathode chamber 102. In various embodiments, the wastewater treatment system 200 further comprises a phosphorous recovery tank 134 in fluid communication with the anode chamber 104.

In certain embodiments, the wastewater treatment system 200 may include a cathode chamber 102 with a gas-permeable membrane manifold 118, where the cathode chamber 102 contains a cathode chamber salt solution 107. The wastewater stream 109, which may contain ammonia and phosphorus, may be pumped into the anode chamber 104. The NH₄ in the anode chamber 104 may permeate into the cathode chamber 102 through the cation exchange membrane 116 placed in between cathode chamber 102 and the anode chamber 104. The cathode 112 may increase the pH of the cathode chamber salt solution 107 and accelerate the rate of passage of ammonia through the gas-permeable membrane 118 into an acid-stripping solution 122 contained in a stripping acid solution tank 120. The acid-stripping solution 122 may be recirculated through the membrane manifold 118. The anode chamber wastewater 108 in the anode chamber 104 may be acidified by H+ released by electrolysis in the anode 114. In some embodiments, when the anode chamber wastewater 108 has an amount of P solubilized, then the anode chamber wastewater 108 may then be transported to the next phase of the wastewater treatment process. In certain embodiments, the anode chamber wastewater 108 with most of the P solubilized (which may be referred to as anode chamber effluent 128) may be passed to a centrifuge 130 or filter to separate the anode chamber wastewater 108 into suspended solids without phosphorus and liquid filtrate or centrate with phosphorus. The liquid filtrate or centrate with phosphorus (which may be referred to as effluent 129) may then be transferred to phosphorous recovery tank 134. In the wastewater treatment system 200, a phosphorus precipitating compound (e.g., MgCl₂ or Ca(OH)₂) may be added to this liquid filtrate or centrate with phosphorus in amounts to match the P concentration of the influent. After rapid mixing, the phosphorus may quickly precipitate as a solid. The phosphorous may then be transported out through a tube 136. Other byproducts or remaining influent may be sent through tube 138 for collection. This precipitation may proceed quickly as a result of the previous removal of the carbonate alkalinity (which can interfere with phosphate precipitation) in the anode chamber 104.

In experiments using the system 200 in FIG. 2, for example, using this configuration in tests with liquid swine manure, the pH in the cathode chamber was increased from 5.8 to 12.5, and the ammonia concentration in the manure wastewater decreased by a net 1640 mg N/L while 86% of the ammonia was recovered in the stripping acid solution tank/reservoir. The wastewater pH dropped from 7.9 to 3.5, and carbonate alkalinity was dropped from 10750 mg/L to 0 mg/L. Using P-precipitating compound Ca(OH)₂, the process recovered 93% of the Total P in a phosphorus precipitate solid compared to only 4.6% in a control without electrochemical treatment. Using P-precipitating compound MgCl₂, the process recovered 95% of the Total P in a phosphorus precipitate solid compared to only 6% P recovery in a control without electrochemical treatment.

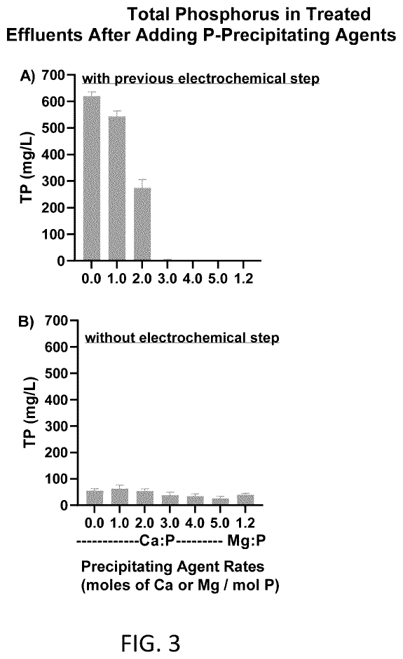

Referring to FIGS. 3A-14, experimental data is shown obtained from tests of the system shown in FIG. 1. This data and results is shown by way of example only.

Materials and Methods: In an example, three chambers anode, cathode, and stripping acid solution were used (250 mL each). The cathode and anode were separated by a cation exchange membrane (CEM) and voltage was provided by an external DC power supply (e.g., GW INSTEK SPS-1230). The cathode may be electrically connected to the power supply by any sufficient material or method, such as by a wire. The anode may be electrically connected to the power supply by any sufficient material or method, such as by a wire. The cathode and anode were platinized titanium with a surface area of 25 cm². The volts and current applied were 4.3V and 0.7 amp. A tubular gas-permeable membrane was placed on cathode chamber and was connected to acid stripping tank in a closed loop. The acid solution (1N H₂SO₄) flow rate was 4.0 mL/min recirculated with a Masterflex L/S pump. The wastewater used was raw swine wastewater from a manure homogenization tank in North Carolina. After electrochemical treatment, the effluent was centrifuged and the phosphorus in the clear supernate was precipitated in 35 mL test tubes using P-precipitating compounds Ca(OH)₂ or MgCl₂.

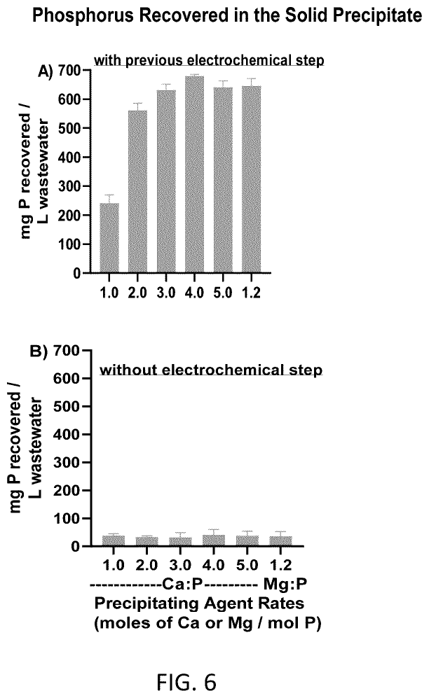

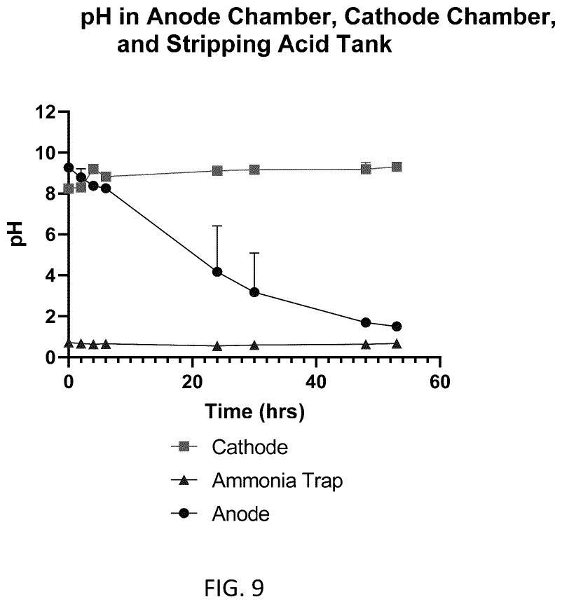

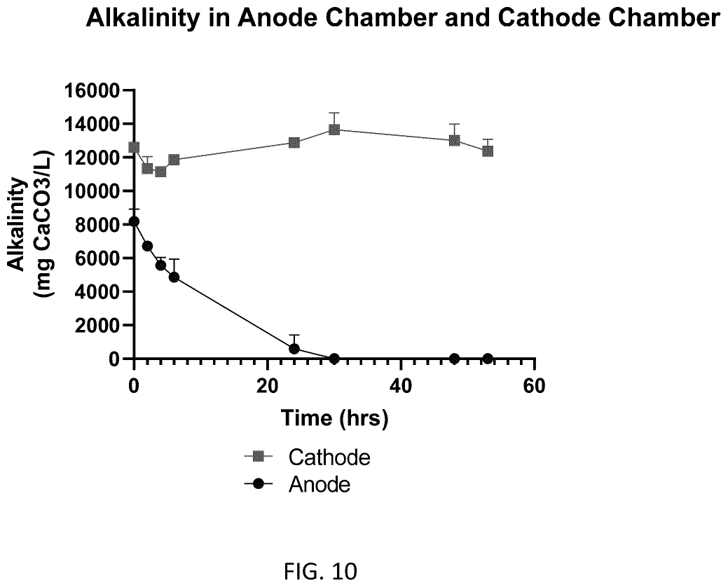

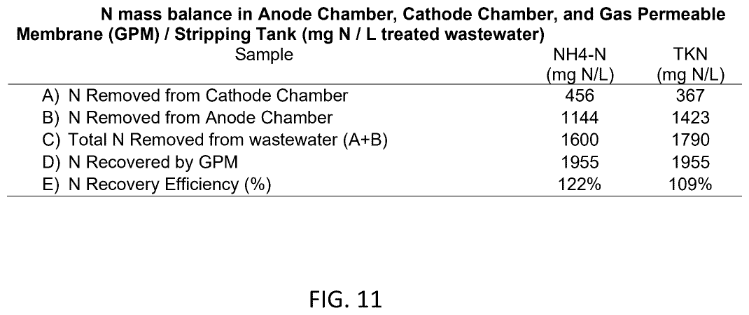

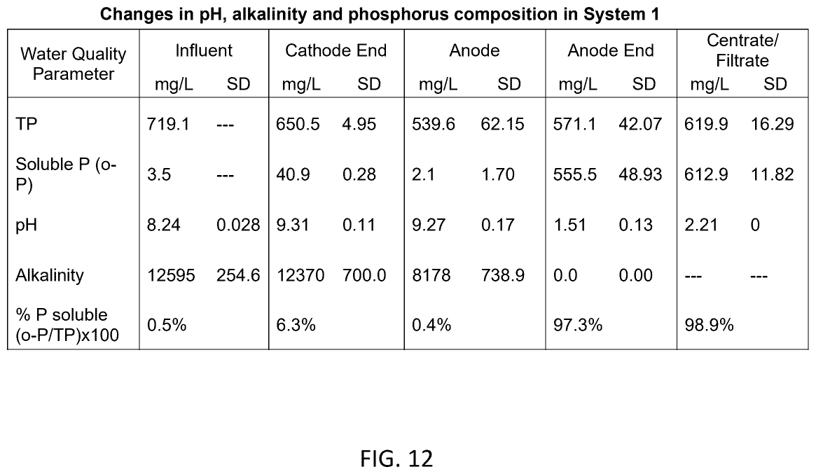

Results Obtained: In some examples using this configuration, in tests using swine manure with 720 mg/L total phosphorus (TP) concentration, only 0.5% (3.5 mg/L) was solubilized (FIG. 12). After electrochemical treatment, 99% of the P was in the form of soluble phosphate (o-P), and amenable to removal with P-precipitating compounds. The liquid pH in the anode chamber dropped to 1.5, and the carbonate alkalinity was destroyed (FIGS. 9-10). The process recovered 94% of the Total P contained in wastewater in a phosphorus solid precipitate (FIGS. 6A-6B). In contrast, only 6% of the total P was recovered in a control that did not receive electrochemical treatment (and acidification) (FIG. 6B). The N recovery efficiency by the membrane module in the cathode chamber was 100% (FIG. 11).

In FIG. 3 there is shown a graph A) showing the total phosphorous in treated effluents after adding P-precipitating agents with a previous electrochemical step, and a graph B) showing the total phosphorous in treated effluents after adding P-precipitating agents without an electrochemical step according to the embodiment shown in FIG. 1 of the present patent document.

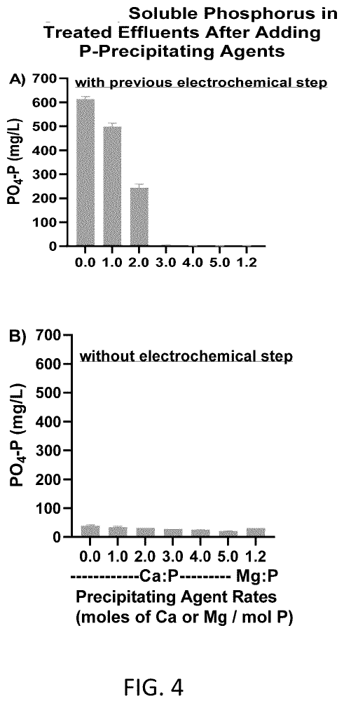

FIG. 4 illustrates a graph A) showing the soluble phosphorous in treated effluents after adding P-precipitating agents with a previous electrochemical step, and a graph B) showing the soluble phosphorous in treated effluents after adding P-precipitating agents without a previous electrochemical step according to the embodiment shown in FIG. 1 of the present patent document.

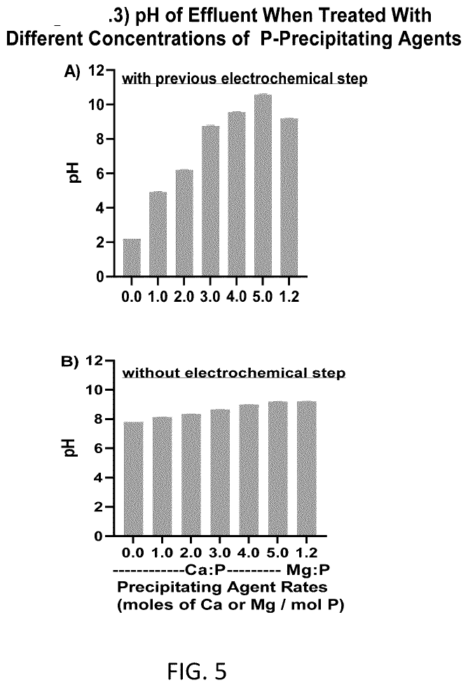

In FIG. 5 there is shown a graph A) showing the pH of effluent when treated with different concentrations of P-precipitating agents with a previous electrochemical step, and a graph B) showing the pH of effluent when treated with different concentrations of P-precipitating agents without a previous electrochemical step according to the embodiment shown in FIG. 1 of the present patent document.

FIG. 6 illustrates a graph A) showing the phosphorous recovered in the solid precipitate with a previous electrochemical step, and a graph B) showing the phosphorous recovered in the solid precipitate without a previous electrochemical step according to the embodiment shown in FIG. 1 of the present patent document.

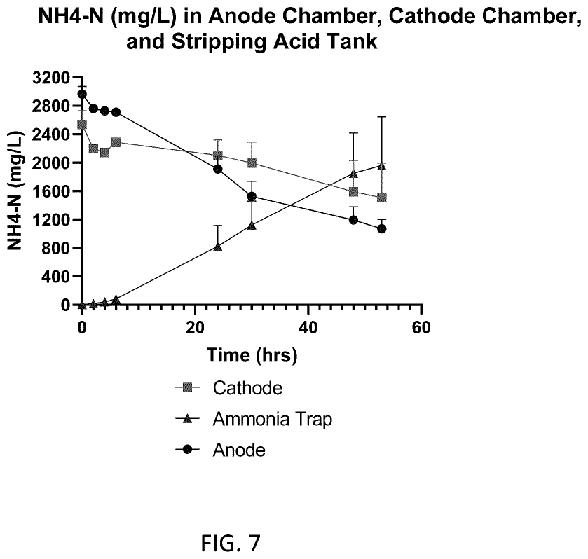

In FIG. 7 there is shown a graph showing the NH₄-N (mg/L) in the anode chamber, cathode chamber, and stripping acid tank according to the embodiment shown in FIG. 1 of the present patent document. In some embodiments, NH4-N is the nitrogen content of the ammonium ion.

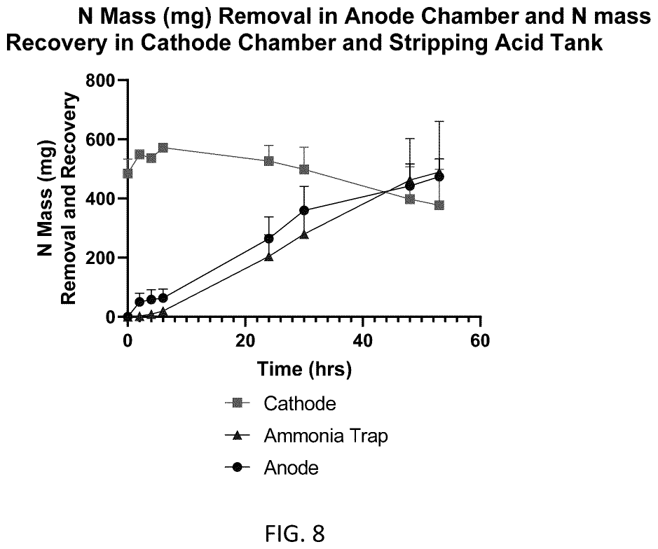

FIG. 8 illustrates a graph showing the N mass (mg) removal in the anode chamber, N mass recovery in the cathode chamber, and stripping acid tank according to the embodiment shown in FIG. 1 of the present patent document.

In FIG. 9 there is shown a graph showing the pH in the anode chamber and the cathode chamber according to the embodiment shown in FIG. 1 of the present patent document.

FIG. 10 illustrates a graph showing the alkalinity in the anode chamber, cathode chamber, and stripping acid tank according to the embodiment shown in FIG. 1 of the present patent document.

In FIG. 11 there is shown a table showing the N mass balance in the Anode Chamber, Cathode Chamber, and Gas Permeable Membrane (GPM)/Stripping Tank (mg N/L treated wastewater) according to the embodiment shown in FIG. 1 of the present patent document.

FIG. 12 illustrates a table showing the changes in pH, alkalinity and phosphorus composition according to the embodiment shown in FIG. 1 of the present patent document. In some embodiments, the anode chamber wastewater 108, with most of the P solubilized, may be passed through a centrifuge 130 or filter to separate solids from liquid, where the resulting solids may be solids without phosphorus, and the liquid may be liquid with phosphorus, mostly as soluble phosphate. This is also shown in FIG. 12, which shows the influent (in the first column) containing 719.1 mg/L total phosphorus (TP), and only 3.5 mg/L of that is soluble phosphate, which provides a ratio of soluble P to TP of 0.5%. However, in the center/filtrate, most of the TP (619.9) is comprised of soluble phosphate (612.9), which provides a ratio of soluble P to total P of 98.9%.

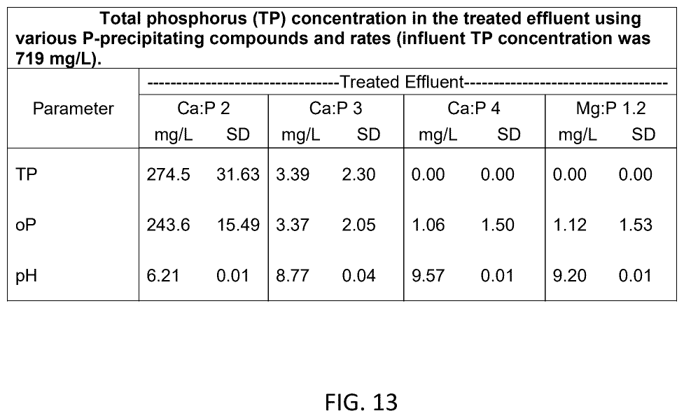

In FIG. 13 there is shown a table showing the total phosphorus (TP) concentration in the treated effluent using various P-precipitating compounds and rates (influent TP concentration was 719 mg/L) according to the embodiment shown in FIG. 1 of the present patent document.

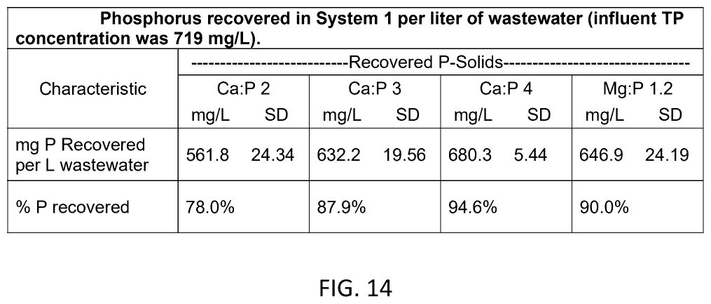

FIG. 14 illustrates a table showing the phosphorus recovered in per liter of wastewater (influent TP concentration was 719 mg/L) according to the embodiment shown in FIG. 1 of the present patent document.

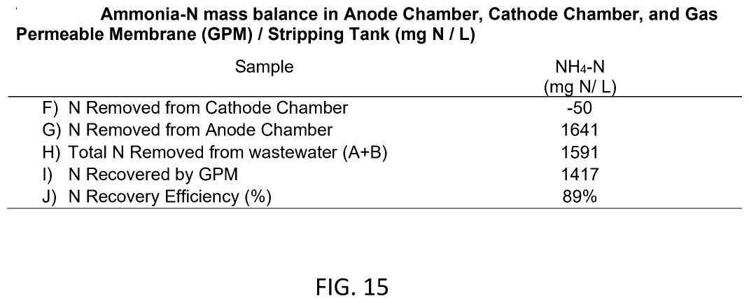

Referring to FIGS. 15-21, experimental data is shown obtained from tests of the system shown in FIG. 2. This data and results is shown by way of example only.

Materials and Methods: In an example, three chambers anode, cathode, and stripping acid solution were used (250 mL each). Cathode and anode were separated by a cation exchange membrane (CEM) and voltage was provided by an external DC power supply (e.g., GW INSTEK SPS-1230). Cathode and anode were platinized titanium with a surface area of 25 cm². Volts and current applied were 4.3V and 0.7 amp. Tubular Philips Scientific Gas-permeable membrane was placed on cathode chamber containing 0.25 M Na₂SO₄ and was connected to the acid stripping tank in a closed loop. Acid solution (1N H₂SO₄) flow rate was 4.0 mL/min recirculated with a pump (e.g., Masterflex L/S pump). The wastewater used was raw swine wastewater from a manure homogenization tank in North Carolina. After electrochemical treatment, the effluent was centrifuged and the phosphorus in the clear supernate was precipitated in 35 mL test tubes using P-precipitating compounds Ca(OH)₂ or MgCl₂.

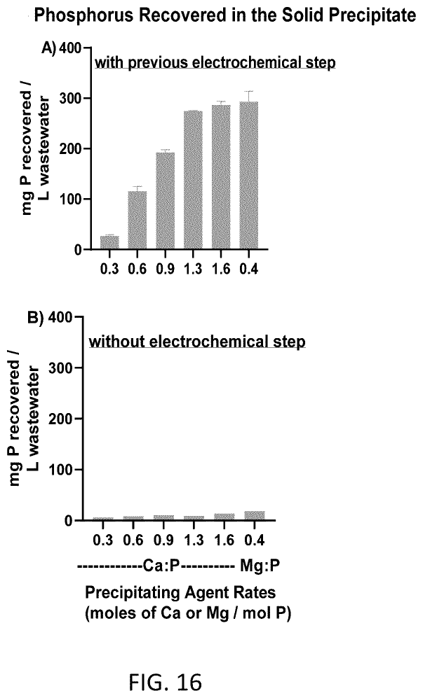

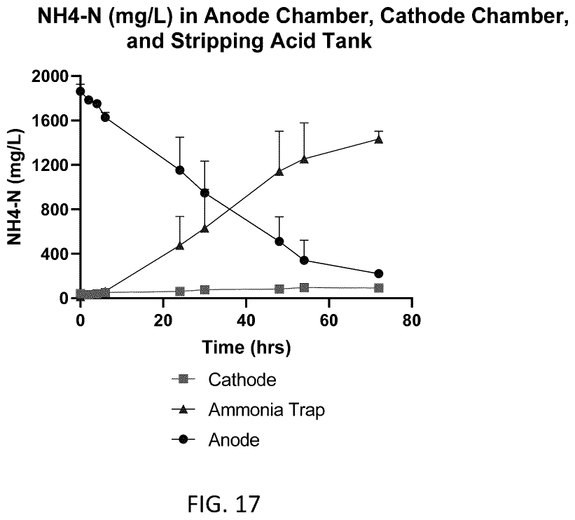

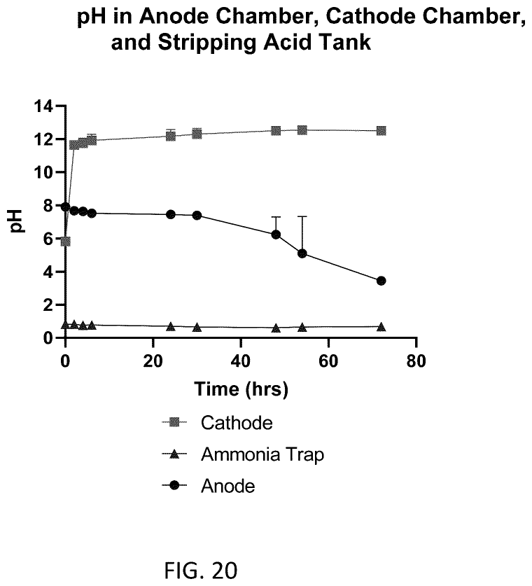

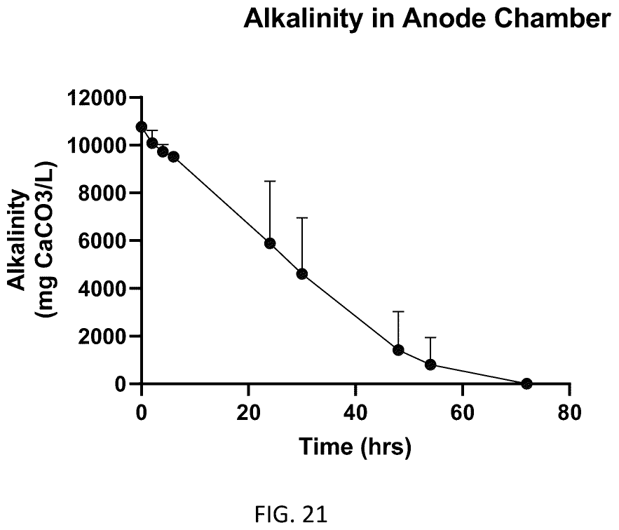

Results Obtained: In some examples using this configuration, in tests with liquid swine manure, the pH in the cathode chamber was increased from 5.8 to 12.5 (FIG. 20), and the ammonia concentration in the manure wastewater decreased by a net 1640 mg N/L while 89% of the ammonia was recovered in the stripping acid solution tank/reservoir (FIGS. 15 and 17). The wastewater pH dropped from 7.9 to 3.5 (FIG. 20), and carbonate alkalinity was dropped from 10750 mg/L to 0 mg/L (FIG. 21). Using P-precipitating compound Ca(OH)₂, the process recovered 93% of the total P in a phosphorus precipitate solid compared to only 4.6% in a control without electrochemical treatment (FIGS. 16A-16B). Using P-precipitating compound MgCl₂, the process recovered 95% of the Total P in a phosphorus precipitate solid compared to only 6% P recovery in a control without electrochemical treatment (FIGS. 16A-16B).

In FIG. 15 there is shown a table showing the Ammonia-N mass balance in anode chamber, cathode chamber, and gas permeable membrane (GPM) with stripping tank (mg N/L) according to the embodiment shown in FIG. 2 of the present patent document.

FIG. 16 illustrates a graph A) showing the phosphate recovered in the solid precipitated with a previous electrochemical step, and a graph B) showing the phosphate recovered in the solid precipitated without a previous electrochemical step according to the embodiment shown in FIG. 2 of the present patent document.

In FIG. 17 there is shown a graph showing the NH-4-N (mg/L) in the anode chamber, the cathode chamber, and the stripping acid tank according to the embodiment shown in FIG. 2 of the present patent document.

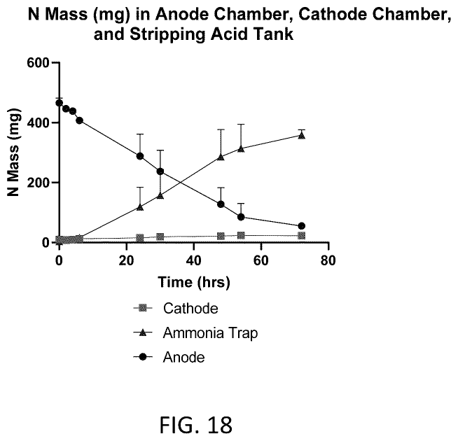

FIG. 18 illustrates a graph showing the N mass (mg) in the anode chamber, the cathode chamber, and the stripping acid tank according to the embodiment shown in FIG. 2 of the present patent document.

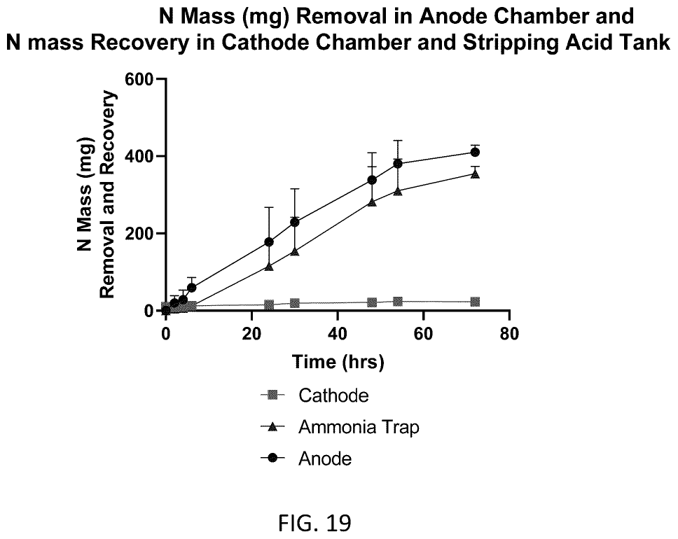

In FIG. 19 there is shown a graph showing the N mass (mg) removal in the anode chamber, the N mass recovery in the cathode chamber, and the stripping acid tank according to the embodiment shown in FIG. 2 of the present patent document.

FIG. 20 illustrates a graph showing the pH in the anode chamber, the cathode chamber, and the stripping acid tank according to the embodiment shown in FIG. 2 of the present patent document.

In FIG. 21 there is shown a graph showing the alkalinity in the anode chamber according to the embodiment shown in FIG. 2 of the present patent document.

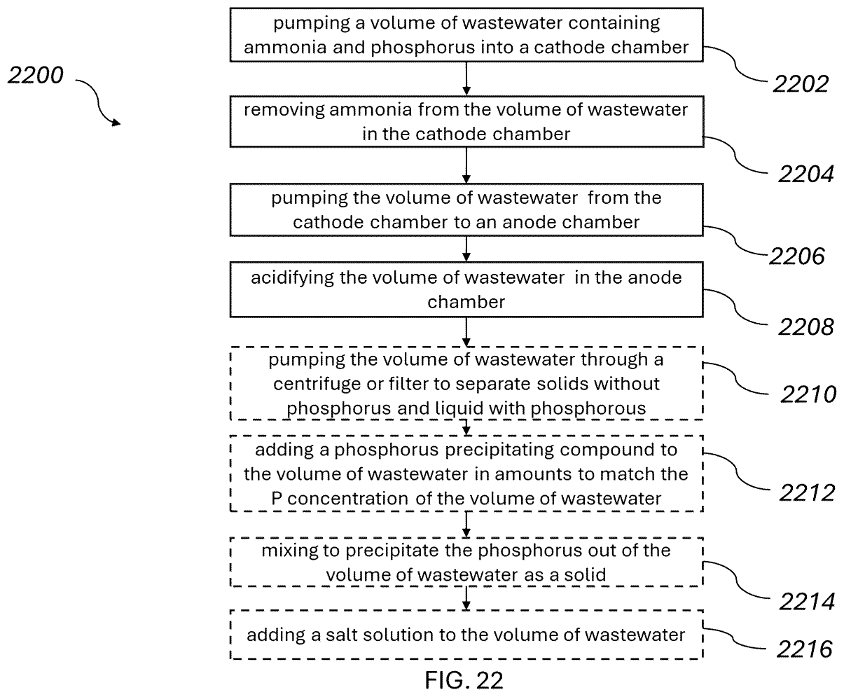

FIG. 22 illustrates a method of treating wastewater in accordance with the present patent document. Referring to FIG. 22, an embodiment of a method 2200 of treating wastewater is shown. In method 2200, step 2202 may comprise pumping a volume of wastewater containing ammonia and phosphorus into a cathode chamber; step 2204 may comprise removing ammonia from the volume of wastewater in the cathode chamber; step 2206 may comprise pumping the volume of wastewater from the cathode chamber to an anode chamber; and step 2208 may comprise acidifying the volume of wastewater in the anode chamber. In some embodiments, step 2202 may comprise pumping a volume of wastewater containing ammonia and phosphorus into a tank, wherein the tank comprises a cathode chamber and an anode chamber.

In some embodiments, step 2202 comprises pumping a volume of wastewater containing ammonia and phosphorus into a cathode chamber. In some embodiments, step 2202 comprises pumping a volume of wastewater containing ammonia and phosphorus into an anode chamber.

In various embodiments, the method further comprises the step 2210 of pumping the volume of wastewater through a centrifuge or filter to separate solids without phosphorus and liquid with phosphorous. In some embodiments, the method further comprises the step 2212 of adding a phosphorus precipitating compound to the volume of wastewater in amounts to match the P concentration of the volume of wastewater. In certain embodiments, the method further comprises the step 2214 of mixing to precipitate the phosphorus out of the volume of wastewater as a solid. In some embodiments, the method further comprises the step 2216 of adding a salt solution to the volume of wastewater. In some embodiments, the salt solution may include sodium sulfate (Na₂SO₄), potassium sulfate (K₂SO₄), potassium chloride (KCl), or sodium chloride (NaCl). In certain embodiments, a salt may be added to the volume of wastewater.

In some embodiments, the cathode 112 may increase the pH of the cathode chamber wastewater 106 and accelerate the rate of passage of ammonia through the gas-permeable membrane 118 submerged in the cathode chamber wastewater 106 and into an acid-stripping solution 122 flowing through the gas-permeable membrane manifold 118. The cathode chamber wastewater 106 with an amount of ammonia removed may then be transferred to the anode chamber 104 where it may be referred to as the anode chamber wastewater 108. The anode chamber wastewater 108 may then be acidified by hydrogen ions (H+) released by electrolysis in the anode 114. A cation exchange membrane 116 may be fitted between the anode chamber 104 and cathode chamber 102, where the cation exchange membrane 116 may allow for the passage of ammonium (NH₄) from the anode chamber 104 into the cathode chamber 102. The anode chamber wastewater 108, may now have most of its P solubilized. The anode chamber wastewater 108, with most of its P solubilized, may then be transferred to a centrifuge 130 or filter to separate solids from the anode chamber wastewater 108. The resulting solids may be solids without phosphorus, and the liquid may be liquid with phosphorus. The liquid with phosphorus may then be transferred to a phosphorous recovery tank 134, where a phosphorus precipitating compound may then be added to this liquid with phosphorus in amounts to match the P concentration of the liquid with phosphate. The liquid with phosphorus and the phosphorous precipitating compound may be rapidly mixed in the phosphorous recovery tank 134, where the phosphorus may then quickly precipitate as a solid and may then be transferred from the phosphorous recovery tank 134 to be collected. The remaining effluent byproducts may then be removed from the wastewater treatment system 100.

In certain embodiments, the wastewater treatment process may use simultaneous separation and recovery of both ammonia and phosphorus from wastewater such as manure and/or municipal effluents. In some embodiments, the wastewater treatment process uses reducing ammonia emissions from liquid effluents and for recovering the ammonia that captures and recovers the ammonia from wastewater using gas-permeable membrane technology. This process is an improvement at least because it incorporates an electrochemical approach to enhance both the gasification and the capture of ammonia by the gas-permeable membrane and the solubilization of the phosphorus for effective precipitation using phosphorus precipitating compounds.

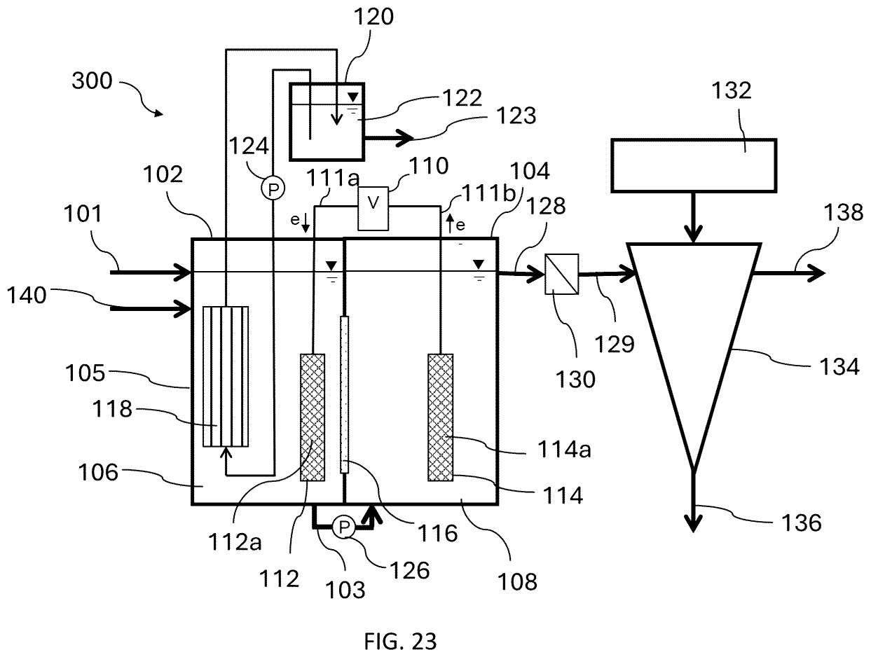

FIG. 23 illustrates a schematic diagram of a side cross sectional view of another embodiment of a system for treating wastewater using electrochemistry of the present patent document. Referring to FIG. 23, there is shown a side cross sectional view of an embodiment of a wastewater treatment system 300 of the present patent document. In some embodiments, the wastewater treatment system 300 may be referred to as a liquid effluent treatment system 300. In various embodiments, the wastewater treatment system 300 may have a cathode chamber 102, where a cathode 112 is disposed in the cathode chamber 102. A wastewater stream 101 may be in fluid communication with the cathode chamber 102. The wastewater treatment system 300 may have an anode chamber 104, where an anode 114 may be disposed in the anode chamber 104. In various embodiments, a salt solution 140 may be added to the wastewater treatment system 300. The salt solution 140 may be added to the wastewater treatment system 300 by any suitable method or in any suitable location. As non-limiting examples, the salt solution 140 may be added to the wastewater stream 101 or the cathode chamber wastewater 106. In some embodiments, a salt may be added to the cathode chamber wastewater 106. In certain embodiments, when a salt or a salt solution is added to the cathode chamber wastewater 106, the resulting mixture may be referred to as a composition or contents of the cathode chamber 102.

In various embodiments, the wastewater treatment system 300 may include a cation exchange membrane 116 disposed between the anode chamber 104 and cathode chamber 102, where the cation exchange membrane 116 allows the passage of ammonium from the anode chamber wastewater 108 of the anode chamber 104 into the cathode chamber wastewater 106 of the cathode chamber 102. In some embodiments, the wastewater treatment system 300 may include a gas-permeable membrane 118 disposed in the cathode chamber 102. In various embodiments, the wastewater treatment system 300 further comprises a phosphorous recovery tank 134 in fluid communication with the anode chamber 104.

In certain embodiments, the wastewater treatment system 300 may include a cathode chamber 102 also with a gas-permeable membrane manifold 118, where the cathode chamber wastewater 106 contains a salt solution 140. The wastewater stream 101 containing ammonia and phosphorus may be pumped into the cathode chamber 102. The NH₄ in the anode chamber 104 may permeate into the cathode chamber 102 through the cation exchange membrane 116 placed in between cathode chamber 102 and the anode chamber 104. The cathode 112 may increase the pH of the cathode chamber wastewater 106 and accelerates the rate of passage of ammonia through the gas-permeable membrane 118 into an acid-stripping solution 122 contained in a stripping acid solution tank 120. The acid-stripping solution 122 may be recirculated through the membrane manifold 118. The anode chamber wastewater 108 in the anode chamber 104 may be acidified by H+ released by electrolysis in the anode 114. In some embodiments, when the anode chamber wastewater 108 has an amount of P solubilized, then the anode chamber wastewater 108 may then be transported to the next phase of the wastewater treatment process. The anode chamber wastewater 108 with most of the P solubilized, which may be referred to as anode chamber effluent 128, may be passed to a centrifuge 130 or filter to separate the anode chamber wastewater 108 into suspended solids without phosphorus and liquid filtrate or centrate with phosphorus. The liquid filtrate or centrate with phosphorus, which may be referred to as effluent 129, may then be transferred to phosphorous recovery tank 134. In the wastewater treatment system 100, a phosphorus precipitating compound (e.g., MgCl₂ or Ca(OH)₂) may be added to this liquid filtrate or centrate with phosphorus in amounts to match the P concentration of the influent. After rapid mixing, the phosphorus may quickly precipitate as a solid. The phosphorous may then be transported out through a tube 136. Other byproducts or remaining influent may be sent through tube 138 for collection. This precipitation may proceed quickly as a result of the previous removal of the carbonate alkalinity, which can interfere with phosphate precipitation, in the anode chamber 104. In some embodiments, a filtrate may be a liquid that has been passed through a filter; and/or a product of filtration. In certain embodiments, a centrate may be a liquid that has been passed through a centrifuge; a product of centrifugation; and/or a concentrated or dense solution or suspension that is obtained through the process of centrifugation.

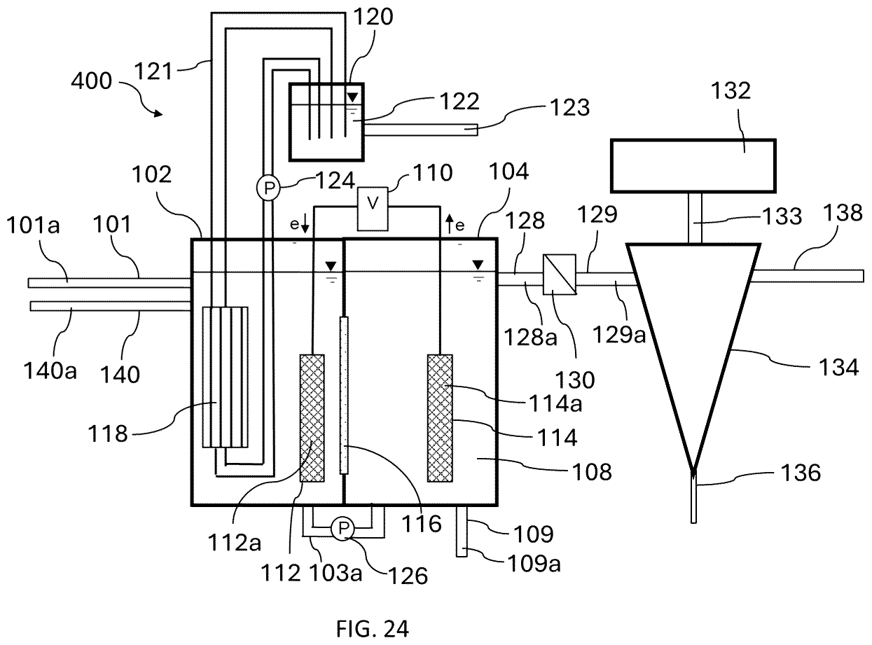

In FIGS. 1-2, and 23, arrows such as 101, 103, 109, 123, 128, 129, 136, 138, and 140 may represent pathways for material to travel from one location to another. In some embodiments, the arrows of 101, 103, 109, 123, 128, 129, 136, 138, and 140 may represent pipes or tubes (see e.g., FIG. 24) which certain material passes through. In other embodiments, the materials may be manually transferred from one location to another by scooping or shoveling the material out of one location and then placing the material in the next location. In addition to pumps 124 and 126, other pumps (not shown) may be used to move some or all of the wastewater, effluents, or fluids from one container or location to another. In various embodiments, a pump may be a peristaltic pump. In other embodiments, other suitable types of pumps may be used.

FIG. 24 illustrates a schematic diagram of a side cross sectional view of another embodiment of a system for treating wastewater using electrochemistry of the present patent document. Referring to FIG. 24, there is shown a side cross sectional view of an embodiment of a wastewater treatment system 400 of the present patent document. In some embodiments, the wastewater treatment system 400 may have pipes or tubes for transferring or moving the wastewater or effluent from one section of the system to another. In various embodiments, the wastewater treatment system 400 may have any combination of tubes or pipes shown in FIG. 24 as needed. In certain embodiments, the wastewater treatment system 400 may have tubes or pipes corresponding to the arrows or pathways of the embodiments of FIG. 1, 2, or 23.

In various embodiments, the wastewater treatment system 400 may have a wastewater stream tube 101a in fluid communication with the cathode chamber 102 to transport the wastewater stream 101 into the cathode chamber 102. In other embodiments, the wastewater stream tube 101a may be a pipe or other device for delivering the wastewater stream 101 to the cathode chamber 102. In some embodiments, the wastewater stream tube 101a may be coupled to the cathode chamber 102. In certain embodiments, the wastewater treatment system 400 may have a wastewater stream tube 109a in fluid communication with the anode chamber 104 to transport the wastewater stream 109 into the anode chamber 104. In some embodiments, a wastewater stream tube 109a may be a pipe or other device for delivering a wastewater stream 109 to the anode chamber 104. In some embodiments, the wastewater stream tube 109a may be coupled to the anode chamber 104. In various embodiments, a salt solution 140 may be added to the wastewater treatment system 400 through a salt solution tube 140a. In other embodiments, the salt solution tube 140a may be a pipe or other device for delivering the salt solution 140 to the cathode chamber 102. In certain embodiments, the wastewater treatment system 400 may have a salt solution tube 140a in fluid communication with the cathode chamber 102 to transport the salt solution 140 into the cathode chamber 102. In some embodiments, the salt solution tube 140a may be coupled to the cathode chamber 102.

In certain embodiments, the wastewater treatment system 400 may have a pump 126, where the pump 126 moves cathode chamber wastewater 106 from the cathode chamber 102 to the anode chamber 104 through a tube 103a. The pump 126 may be in fluid communication with the cathode chamber 102 and the anode chamber 104 through tube 103a. In some embodiments, the tube 103a may be coupled to the cathode chamber 102 at one end and coupled to the anode chamber 104 at another end. In certain embodiments, the pump 126 may be coupled to tube 103a. In certain embodiments, the tube 103a may be a pipe or other device for delivering the wastewater 106 from the cathode chamber 102 to the anode chamber 104. The cathode chamber 102 and anode chamber 104 may be any size and shape as needed to accommodate a volume of wastewater. In certain embodiments, the cathode chamber 102 and anode chamber 104 are over halfway filled with wastewater (e.g., over 50% filled). In some embodiments, the cathode 112 is completely submerged in the cathode chamber wastewater 106. In certain embodiments, the anode 114 is completely submerged in the anode chamber wastewater 108. In some embodiments, the cathode 112 is partially submerged in the cathode chamber wastewater 106. In various embodiments, the anode 114 is partially submerged in the anode chamber wastewater 108.

In certain embodiments, the wastewater treatment system 400 may have a pump 124, where the pump 124 moves the stripping solution 122 through a tube 121 and through a gas-permeable membrane 118. The stripping solution 122 may be circulated from the stripping tank 120 through a tube 121 such that the stripping solution 122 collects ammonia from the cathode chamber 102 through the gas-permeable membrane 118, and then returns the stripping solution 122 now with ammonia salts to the stripping tank 120 for collection. The byproduct containing ammonia salts may then be removed and collected by a tube 123. In certain embodiments, the tube 121 may be coupled to the stripping tank 122. In some embodiments, the tube 123 may be coupled to the stripping tank 122.

In certain embodiments, the anode chamber wastewater 108, with most of the P solubilized, may then be passed by a tube 128a to a centrifuge 130 or filter to separate the anode chamber wastewater 108 into suspended solids without phosphorus and liquid filtrate or centrate with phosphorus. The liquid filtrate or centrate with phosphorus effluent 129 may then be transferred to phosphorous recovery tank 134 by a tube 129a. In other embodiments, the tube 129a may be a pipe or other device for delivering the liquid filtrate or centrate with phosphorus effluent 129 to the phosphorous recovery tank 134. In the wastewater treatment system 400, a phosphorus precipitating compound (MgCl₂ or Ca(OH)₂) from a phosphorus precipitating agent dispenser 132 may be added to this liquid filtrate or centrate with phosphorus in amounts to match the P concentration of the influent. In some embodiments, the filtrate or centrate may contain phosphate. In some embodiments, the phosphorus precipitating agent from the phosphorus precipitating agent dispenser 132 may be added to the phosphorous recovery tank 134 by a tube 133. After rapid mixing, the phosphorus may quickly precipitate as a solid. The phosphorous may then be transported out through a tube 136. In other embodiments, the tube 136 may be a pipe or other device for delivering the phosphorous out of the phosphorous recovery tank 134. Tube 136 may be coupled to the phosphorous recovery tank 134. Other byproducts or remaining influent may be sent through tube 138 for collection. Tube 138 may be coupled to the phosphorous recovery tank 134. In other embodiments, the tube 138 may be a pipe or other device for delivering the byproducts or remaining influent from the phosphorous recovery tank 134. This precipitation may proceed quickly as a result of the previous removal of the carbonate alkalinity in the anode chamber 104.

In some embodiments, the tube 128a may be coupled to the anode chamber 104 at one end and coupled to the filter or centrifuge 130 at another end. In certain embodiments, the tube 129a may be coupled to the filter or centrifuge 130 at one end, and coupled to the phosphorous recovery tank 134 at another end. In some embodiments, the phosphorus precipitating agent dispenser 132 may be coupled to the phosphorous recovery tank 134 by a tube 133.

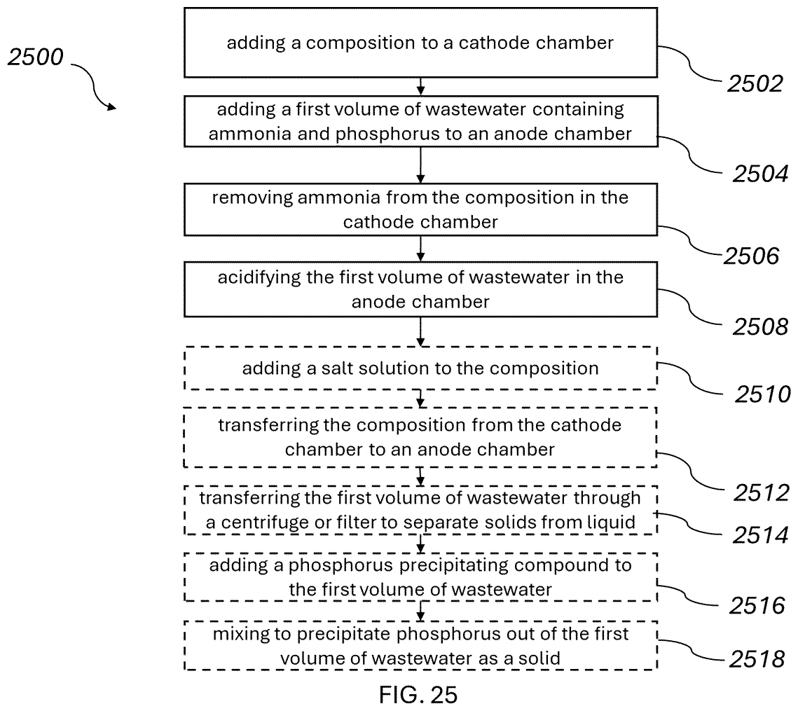

FIG. 25 illustrates a method of treating wastewater in accordance with the present patent document. Referring to FIG. 25, an embodiment of a method 2500 of treating wastewater is shown. In method 2500, step 2502 may comprise adding a composition to a cathode chamber, wherein a cathode is disposed in the cathode chamber. Step 2504 may comprise adding a first volume of wastewater containing ammonia and phosphorus to an anode chamber, wherein an anode is disposed in the anode chamber. Step 2506 may comprise removing ammonia from the composition in the cathode chamber. Step 2508 may comprise acidifying the first volume of wastewater in the anode chamber.

In some embodiments, the composition is a second volume of wastewater. In various embodiments, the composition is a salt solution. In certain embodiments, the method 2500 further comprises the step 2510 of adding a salt solution to the composition. In some embodiments, the method 2500 further comprises the step 2512 of transferring the composition from the cathode chamber to an anode chamber. In various embodiments, the method 2500 further comprises the step 2514 of transferring the first volume of wastewater through a centrifuge or filter to separate solids from liquid. In certain embodiments, the method 2500 further comprises the step 2516 of adding a phosphorus precipitating compound to the first volume of wastewater. In some embodiments, the method 2500 further comprises the step 2518 of mixing the phosphorus precipitating compound and the first volume of wastewater to precipitate phosphorus out of the first volume of wastewater as a solid. In various embodiments, a cation exchange membrane is disposed between the anode chamber and cathode chamber, wherein the cation exchange membrane allows the passage of ammonium from the anode chamber into the cathode chamber. In some embodiments, a power supply is electrically connected to the cathode and the anode.

Although the embodiments have been described with reference to the drawings and specific examples, it will readily be appreciated by those skilled in the art that many modifications and adaptations of the apparatuses and processes described herein are possible without departure from the spirit and scope of the embodiments as claimed hereinafter. Thus, it is to be clearly understood that this description is made only by way of example and not as a limitation on the scope of the embodiments as claimed below.

For the foregoing reasons, the subject matter described herein provides innovative systems and methods for treating wastewater using electrochemistry. The current system may be modified in multiple ways and applied in various technological applications. The disclosed apparatus, systems, and methods may be modified and customized as required by a specific operation or application, and the individual components may be modified and defined, as required, to achieve the desired result.

Although the materials of construction are not described, they may include a variety of compositions consistent with the function described herein. Such variations are not to be regarded as a departure from the spirit and scope of this disclosure, and all such modifications as would be obvious to one skilled in the art are intended to be included within the scope of the following claims.

The amounts, percentages and ranges disclosed in this specification are not meant to be limiting, and increments between the recited amounts, percentages and ranges are specifically envisioned as part of the invention. All ranges and parameters disclosed herein are understood to encompass any and all sub-ranges subsumed therein, and every number between the endpoints. For example, a stated range of “1 to 10” should be considered to include any and all sub-ranges between (and inclusive of) the minimum value of 1 and the maximum value of 10 including all integer values and decimal values; that is, all sub-ranges beginning with a minimum value of 1 or more, (e.g., 1 to 6.1), and ending with a maximum value of 10 or less, (e.g. 2.3 to 9.4, 3 to 8, 4 to 7), and finally to each number 1, 2, 3, 4, 5, 6, 7, 8, 9, and 10 contained within the range.

Unless otherwise indicated, all numbers expressing quantities of ingredients, properties such as molecular weight, reaction conditions, and so forth as used in the specification and claims are to be understood as being modified in all instances by the implied term “about.” The (stated or implied) term “about” indicates that a numerically quantifiable measurement is assumed to vary by as much as 30 percent, but preferably by at least 10%. Essentially, as used herein, the term “about” refers to a quantity, level, value, or amount that varies by as much 10% to a reference quantity, level, value, or amount. Accordingly, unless otherwise indicated, the numerical properties set forth in the following specification and claims are approximations that may vary depending on the desired properties sought to be obtained in embodiments of the present invention.

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described.

The term “consisting essentially of” excludes additional method (or process) steps or composition components that substantially interfere with the intended activity of the method (or process) or composition, and can be readily determined by those skilled in the art (for example, from a consideration of this specification or practice of the invention disclosed herein). The invention illustratively disclosed herein suitably may be practiced in the absence of any element which is not specifically disclosed herein. The term “an effective amount” as applied to a component or a function excludes trace amounts of the component, or the presence of a component or a function in a form or a way that one of ordinary skill would consider not to have a material effect on an associated product or process.

What is claimed is:

1. A wastewater treatment system comprising:
a cathode chamber, wherein the cathode chamber is configured to receive a volume of wastewater;
a cathode, wherein the cathode is configured to be disposed in the cathode chamber;
an anode chamber, wherein an anode is configured to be disposed in the anode chamber;
a pump, wherein the pump is configured to move the volume of wastewater from the cathode chamber to the anode chamber; and
a cation exchange membrane disposed between the anode chamber and cathode chamber, wherein the cation exchange membrane allows the passage of ammonium from the anode chamber into the cathode chamber.

2. The wastewater treatment system of claim 1, further comprising a phosphorous recovery tank.

3. The wastewater treatment system of claim 1, wherein a salt solution is added to the cathode chamber.

4. The wastewater treatment system of claim 3, wherein the salt solution comprises sodium sulfate, potassium sulfate, potassium chloride, or sodium chloride.

5. The wastewater treatment system of claim 1, wherein a salt is added to the cathode chamber.

6. The wastewater treatment system of claim 1, wherein carbonate alkalinity is capable of being removed in the anode chamber.

7. The wastewater treatment system of claim 1, wherein the cathode chamber further comprises a submerged gas-permeable membrane manifold, and wherein ammonia is capable of being removed from the volume of wastewater in the cathode chamber.

8. The wastewater treatment system of claim 1, wherein the cathode is a platinized titanium cathode, or wherein the anode is a platinized titanium anode.

9. The wastewater treatment system of claim 1, further comprising a centrifuge or a filter, wherein the centrifuge or the filter is in fluid communication with the anode chamber and the phosphorous recovery tank.

10. The wastewater treatment system of claim 1, further comprising a power supply electrically connected to the cathode and the anode.

11. The wastewater treatment system of claim 1, further comprising a phosphorus precipitating agent dispenser.

12. The wastewater treatment system of claim 11, wherein a phosphorus precipitating compound is added to the volume of wastewater.

13. The wastewater treatment system of claim 12, wherein the phosphorus precipitating compound is an alkaline earth metal-containing salt or hydroxide selected from the group comprising calcium, magnesium, and mixtures thereof.

14. A liquid effluent treatment system comprising:
a cathode chamber, wherein a cathode is disposed in the cathode chamber, wherein the cathode chamber is configured to receive a liquid effluent, and wherein the cathode chamber is configured to receive a solution comprising a salt;
an anode chamber, wherein an anode is disposed in the anode chamber, and wherein the anode chamber is configured to receive a liquid effluent;
a cation exchange membrane disposed between the anode chamber and cathode chamber, wherein the cation exchange membrane is configured to allow the passage of ammonium from the anode chamber into the cathode chamber.

15. The liquid effluent treatment system of claim 14, further comprising a gas-permeable membrane in gaseous communication with the cathode chamber.

16. The liquid effluent treatment system of claim 15, further comprising a stripping tank containing an acid-stripping solution, wherein the cathode increases the pH of the liquid effluent and accelerates the rate of passage of ammonia through the gas-permeable membrane into an acid-stripping solution contained in the stripping tank, wherein the acid-stripping solution is recirculated through the gas-permeable membrane.

17. The liquid effluent treatment system of claim 14, wherein the salt comprises sodium sulfate, potassium sulfate, potassium chloride, or sodium chloride.

18. A wastewater treatment system comprising:
a cathode chamber, wherein the cathode chamber is configured to receive a salt solution;
a cathode, wherein the cathode is configured to be disposed in the cathode chamber; and
an anode chamber wherein the anode chamber is configured to receive a volume of wastewater; and
an anode, wherein the anode is configured to be disposed in the anode chamber.

19. The wastewater treatment system of claim 18, further comprising a cation exchange membrane disposed between the anode chamber and cathode chamber, wherein the cation exchange membrane is configured to allow the passage of ammonium from the anode chamber into the cathode chamber.

20. The wastewater treatment system of claim 18, further comprising a gas-permeable membrane disposed in the cathode chamber.

21. The wastewater treatment system of claim 18, further comprising a phosphorous recovery tank in fluid communication with the anode chamber.

22. The wastewater treatment system of claim 18, further comprising a power supply, wherein the power supply is electrically connected to the cathode and the anode.

23. A method of treating wastewater, the method comprising the steps of:
adding a composition to a cathode chamber, wherein a cathode is disposed in the cathode chamber;
adding a first volume of wastewater containing ammonia and phosphorus to an anode chamber, wherein an anode is disposed in the anode chamber;
removing ammonia from the composition in the cathode chamber, and
acidifying the first volume of wastewater in the anode chamber.

24. The method of claim 23, wherein the composition is a second volume of wastewater.

25. The method of claim 23, wherein the composition is a salt solution.

26. The method of claim 24, further comprising the step of: adding a salt solution to the composition.

27. The method of claim 23, further comprising the step of: transferring the composition from the cathode chamber to an anode chamber.

28. The method of claim 23, further comprising the step of: transferring the first volume of wastewater through a centrifuge or filter to separate solids from liquid.

29. The method of claim 23, further comprising the steps of: adding a phosphorus precipitating compound to the first volume of wastewater; and
mixing to precipitate phosphorus out of the first volume of wastewater as a solid.

30. The method of claim 23, wherein a cation exchange membrane is disposed between the anode chamber and cathode chamber, wherein the cation exchange membrane allows the passage of ammonium from the anode chamber into the cathode chamber; and
wherein a power supply is electrically connected to the cathode and the anode.
